(19) United States
(12) Patent Application Publication
(10) Pub. No.: US 2005/0044003 A1
(43) Pub. Date: Feb. 24, 2005

(54) Electronic mail transactions

(75) Inventors: Kieran O'Keeffe, London (GB); Matthew Williams, Whitstable (GB)

Correspondence Address: ARENT FOX KINTNER PLOTKIN & KAHN, 1050 CONNECTICUT AVENUE, N.W., SUITE 400, WASHINGTON, DC, 20036, US

(73) Assignee: Smartmarket Technologies Ltd.

(21) Appl. No.: 10/724,688

(22) Filed: Dec. 2, 2003

(30) Foreign Application Priority Data
Aug. 22, 2003 (GB) GB0319861.1

(51) Int. Cl. G06F 17/60

(52) U.S. Cl. 705/26

(57) ABSTRACT

The invention relates to systems and methods for conducting a transaction via an electronic mail message. An electronic mail message 3 is sent from a first server component 1 to a recipient 2 and received at the recipient's client mail application. The client mail application displays the message to the recipient enabling them to interact with the message 3. The electronic mail message 3 has content that enables communication with a second server component whilst the message is displayed to the recipient 2. Data is sent to the second server component in response to the recipient's interaction with the message. Once received by the second server component, the data is used by a third server component to effect a transaction.

### FIELD OF THE INVENTION

The present invention relates to systems and methods for conducting transactions via electronic mail. It is particularly, although not necessarily exclusively, concerned with the completion of e-commerce transactions.

### BACKGROUND

In recent years there has been an explosion in the use of electronic mail (‘email’) as a tool for direct marketing to consumers. Indeed, it is fair to say that in the last two years the direct marketing fraternity has embraced email as the tool of choice for one to one cost effective marketing campaigns. There is still a dilemma, however, surrounding how one initiates an interactive relationship with the recipient of such an email and ultimately converts them into a customer.

The normal approach taken in such direct marketing is to use the email to entice its recipient to contact the organisation for which the marketing campaign is being run. Typically this is achieved by directing the recipient to the home page of that organisation's web site, or in more sophisticated cases to the page of their web site that is most relevant to the content of the marketing campaign (e.g. by providing a link to the web page within the body of the email).

This approach suffers from the disadvantage that the recipient of the email must leave their email application to interact with the organisation's web site via a separate browser application. It is well known that in an online environment each successive page load between ‘call to action’ or ‘offer’ and completed transaction leads to a significant number of consumers abandoning a transaction before completion. It has also been shown that a critically high point of abandonment exists where the consumer must launch additional browser windows. The effectiveness of direct marketing campaigns reliant on emails is severely restricted as a consequence.

A number of schemes have been suggested for conducting a transaction using only email communication between a supplier and a purchaser, avoiding the need to redirect a purchaser to a web site.

For example, GB2333878 (Citibank) describes a system for conducting a financial transaction between a purchaser and a supplier in a secure manner online. A secure electronic payment instruction is sent from the purchaser to the supplier via the Internet as an email or through interaction with a web page. The supplier appends further payment instructions and forwards the instruction to a financial institution, again securely via the Internet. The financial institution has secure electronic access to the bank accounts of the purchaser and supplier to effect the financial transaction.

Similarly, U.S. Pat. No. 6,101,485 (IBM) describes a system for engaging in electronic commerce over the Internet. A potential purchaser is sent an email giving details of the product available from an e-commerce web site and soliciting them to purchase the product. The email includes a link that can be selected by the purchaser to create and send a second email message to the e-commerce site in order to make the purchase. The purchaser must be registered with the e-commerce site, where their payment information is already held in order that the purchase can be perfected without the need to transmit payment information in the second email.

WO 02/069228 describes a more sophisticated system for conducting predefined transactions through the sending and receiving of electronic mails. Sender and recipient devices have access to a predefined set of rules, which are invoked during settlement of a transaction. An electronic mail is sent from the sender to the recipient and prescribes a reply action for confirming agreement to conduct a transaction offered in the email. When the recipient performs the prescribed reply action, one of the predefined rules (identified by the email content) is applied in order to gather from the recipient's device relevant data required for the transaction. The rules operate to construct a second electronic mail containing the gathered data that is then sent back to the sender to effect the transaction.

Whilst these approaches allow the consumer to remain in their email application whilst completing a transaction, avoiding the problems associated with redirection to a web site, they lack the level of interaction that a consumer can experience in a browser environment when conducting a transaction with a web page. The effectiveness of marketing campaigns built around such email transactions is also therefore doubtful.

### SUMMARY OF THE INVENTION

The present invention is generally concerned with providing systems and methods for conducting a transaction (e.g. an e-commerce transaction involving a payment) in an electronic mail environment that offers advantages over the prior art discussed above. A particularly preferred aim of the invention is to provide such systems and methods that can be employed in email marketing campaigns to greater effect than the conventional approaches to such marketing discussed above.

In a first aspect, the invention provides a system for conducting a transaction via an electronic mail message, the system comprising:
a first server component for sending an electronic mail message to a recipient;
a second server component for receiving data;
a third server component for effecting a transaction in response to data received by the second server component;
a client mail application for receiving the electronic mail message from the first server component, displaying the message to the recipient and enabling a recipient to interact with the message;
the electronic mail message comprising content that includes means for enabling communication with the second server component whilst the message is displayed to the recipient for sending data to the second server component in response to the recipient's interaction with the message.

In a second aspect, the invention provides a server system for conducting a transaction via an electronic mail message, the server system comprising:
a first server component for sending an electronic mail message to a recipient;
a second server component for receiving data; and
a third server component for effecting a transaction in response to data received by the second server component;
the electronic mail message comprising content that includes means for enabling communication with the second server component whilst the message is displayed to the recipient for sending data to the second server component in response to a recipient's interaction with the message.

In a third aspect, the invention provides an electronic mail message comprising content that includes means for enabling communication with a server component whilst the message is displayed to a recipient for sending data to the second server component in response to interaction of the recipient with the displayed message.

In a fourth aspect, the invention provides a method for conducting a transaction via an electronic mail message, the method comprising:
sending an electronic mail message from a first server component to a recipient;
receiving the electronic mail message at a client mail application, the mail application displaying the message to the recipient and enabling the recipient to interact with the message;
in response to interaction of the recipient with the electronic mail message, the message content operating to communicate with a second server component whilst the message is displayed to the recipient to send data to the second server component;
the second server component receiving the sent data; and
effecting a transaction in response to the data received by the second server component.

In a fifth aspect, the invention provides a method for conducting a transaction via an electronic mail message, the method comprising:
sending an electronic mail message from a first server component to a recipient, the electronic mail message comprising content that includes means for enabling communication with a second server component whilst the message is displayed to the recipient for sending data to the second server component in response to the recipient's interaction with the message;
receiving at the second server component data sent in response to interaction of the recipient with the electronic mail message; and
effecting a transaction in response to the data received by the second server component.

In a sixth aspect, the invention provides a method for conducting a transaction via an electronic mail message, the method comprising:
receiving an electronic mail message at a client mail application, the mail application displaying the message to a recipient and enabling the recipient to interact with the message;
in response to interaction of the recipient with the electronic mail message, the message content operating to communicate with a second server component whilst the message is displayed to the recipient to send data to the second server component in order to effect the transaction.

In the various aspects of the invention set out above, in addition to receiving data from the mail message it is particularly preferred that the second server component (or another of the server components, or one or more further server components) is able to send data to the mail message, for instance to provide content for the message or other responses to the data sent from the message.

In this way, it becomes possible to enable two-way communication between an electronic mail message displayed to the recipient and one or more server components, potentially including multiple data communications to and from the mail message or even continuous communication between the mail message and the server component(s). This approach can allow a recipient to complete a transaction entirely from within the body of a single electronic mail message, offering significant advantages over the prior art discussed above.

The content of the electronic mail message for enabling communication with the second server component may comprise an object or component embedded in the message (e.g. in the HTML code of a message).

Alternatively, and more preferably, the content that provides this function comprises means (e.g. HTML code) for loading, on or after opening of the message, an object or component to be displayed within the mail message to the recipient. The message content may include, for example, a call to a server component to download a message object or message component from the server component.

The object or component (either embedded in the message or subsequently loaded) may comprise a flash movie, a Java applet or other plug-in component or virtual machine, or other mail reader application components or enhancements that provide a dynamic environment with which a recipient of the message can interact.

In particularly preferred embodiments both the communication with the server component and the interaction with the recipient are carried out by the flash movie or Java applet (or equivalent object/component). Not only does this easily enable data captured from the recipient's interactions to be communicated back to the server component, but also it readily enables validation of the recipient's interactions in real time.

For instance, a flash movie or Java applet (or other equivalent object/component) can be built to validate data entered by a recipient against fixed rules set within the movie or applet itself (e.g. is a date format correct?). Where a data entry is invalid, the movie or applet can flag this up to the recipient immediately.

Additionally or alternatively, the movie or applet (or equivalent object/component) can use the communication link with the second server component (or another of the server components, or one or more further server components) to dynamically validate data (e.g. to validate a postcode/zip code against an external database). External validation such as this may take place through direct communication between the mail message and a third party server system or web service for instance.

The object (e.g. flash movie or Java applet) may be ‘sand-boxed’, that is to say contained in a protected environment within the mail message in which they are isolated from the client device on which they are displayed. This may help to moderate any security concerns a recipient might have.

The electronic mail messages of preferred embodiments of the invention also include alternative content that is visible to the recipient in the event that the means for communicating with the second server component is inoperable, for instance if it is incompatible or barred by the recipients mail application. This alternative content may, for example, be a link to a web page from which the transaction can be effected.

The email can be delivered to the recipient's mail application in any appropriate manner, and will typically be delivered over an electronic communications network (wired and/or wireless) such as a LAN, WAN, the Internet, cellular wireless networks (e.g. GPRS or 3G) or a combination of such networks.

Similarly, the communication between the content of the electronic mail message and the second, other or further server components may be over a communications network (wired and/or wireless), for example a LAN, WAN, the Internet, cellular wireless networks (e.g. GPRS or 3G) or a combination of such networks. Preferred embodiments of the invention conduct this communication using HTTP or, more preferably HTTPS (for at least those data elements that might be considered private or otherwise sensitive).

In preferred embodiments of the invention, the system includes a server component for generating the electronic mail message to be sent. Conveniently, the message may be generated using one or more templates made available to the message generation server component.

It will also be desirable in some instances for the message to be personalised for a particular recipient or group of recipients.

The client mail application may be conventional and typically the system will employ a standard application that has been preinstalled on a client device (e.g. a personal computer, personal digital assistant, mobile telephone, set-top box, digital television or other such device) used by the recipient. Appropriate mail applications include Microsoft Outlook. Alternatively the recipient may use a web-based mail application with which they interact using a browser application on their client device.

The interaction of the recipient with the mail message may take various forms including, for example, use of an input device such as a keyboard, mouse, trackball or stylus to enter text or to select buttons, links or other features such as check boxes, radio buttons, drop down lists, etc.

The operation of the third server component to effect the transaction will depend on the nature of the transaction itself. The effecting of the transaction may include a single operation as simple as storing the received data in a data store or forwarding the data to another address, application, service or system. In some embodiments, where for example the transaction relates to an order for the purchase of goods or services, the third server component may interact with one or more payment gateways and/or other applications, services or systems responsible for fulfilment of the order.

In the various aspects of the invention set out above, the server components may be combined in a single server application or may be distributed between multiple applications. Similarly the server components may be physically located at a single server device or distributed amongst multiple server devices.

The invention also provides computer software (which may comprise a single or multiple components), which when installed and run on a computer system (which may comprise a single device or multiple local and/or distributed devices) causes the system to operate in accordance with one or more of the various aspects of the invention set out above.

As used above and in the remainder of this specification (unless the context requires otherwise) the term “transaction” is intended to include (although not necessarily be limited to) any interaction with the recipient in which they are required to provide or consent to the provision of data to another person or entity. Examples of transactions include but are not limited to the ordering, purchase or sale of goods or services, charitable donations, accepting free promotional goods or services, bill payment, membership and enrolment transactions, participation in market research, polls, surveys and the like.

Examples of the data provided by the recipient (or the provision of which the recipient consents to) include personal information such as name, age or address, payment information such as credit card or bank account details, order information such as a product identifier or quantity or date of travel, responses to survey questions, etc.

### BRIEF DESCRIPTION OF THE DRAWING

The invention is described below, by way of example, with reference to the accompanying drawings in which:

FIG. 1 shows, schematically, a client-server system in accordance with an embodiment of the present invention;

FIGS. 2a, 2b and 2c illustrate processes by which the server side components of the system of FIG. 1 operate;

FIGS. 3a and 3b illustrate processes by which the client side components of the system of FIG. 1 can operate;

FIG. 4 illustrates the manner in which the system of FIG. 1 operates to determine the form in which a marketing message is presented to a consumer at the client device based on the capabilities on the client device; and

FIGS. 5a to 5d show the visible content of a transactional marketing email in accordance with an embodiment of the present invention, as seen by the consumer during the course of a transaction

### DESCRIPTION OF AN EMBODIMENT

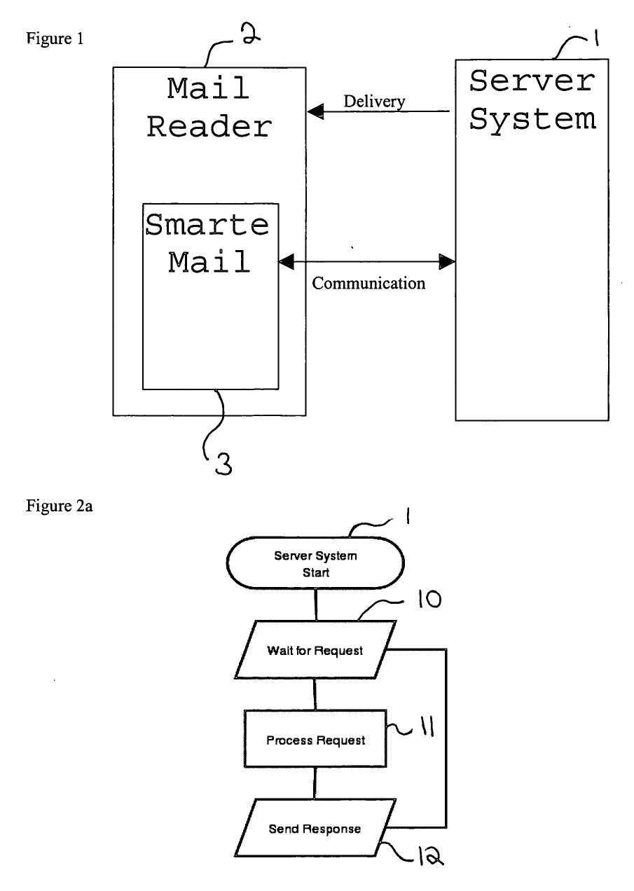

FIG. 1 shows a system that, in accordance with an embodiment of the invention, can deliver an email to a recipient (e.g. a consumer) and enable the recipient to complete a transaction with a supplier from within the body of the email itself. The transaction can be completed without the need to leave the email at any point during the course of the transaction.

Emails in accordance with the present invention (“SmarteMails”) are created and sent out from a server system 1 for delivery to multiple recipients at one or more client side systems 2. The client side system 2 includes a mail application that can be used to view and interact with an email 3 (e.g. the “SmarteMail”) received from the server system 1.

The “SmarteMail” content includes a transaction component (e.g. a flash movie) that allows the user to enter required details such as name, delivery address and credit card number to enable the transaction to be processed. Details entered into the email are validated for correctness upon entry so that a user error message can be generated if the user enters incorrect data such as a letter instead of a number for credit card issue number for example. Further validation can be carried out prior to execution of the transaction through the server system, such as real-time Postcode searches or credit card account checking, so that the delivery address can be verified.

Once the user has entered all requisite information he/she is presented with an order page which seeks affirmation of the action about to be taken. Once granted the transaction details are securely communicated to server and a response is returned. On successful completion the user is presented with a confirmation page.

This entire sequence is conducted within the body of one email.

The email generated at the server side can be personalised so that the mail may be tailored to an individual recipient's profile. It may contain multiple offers and products.

This approach, when adopted in a marketing campaign can significantly reduce abandonment rates experienced by other email marketing methods and thereby increases the ROI (return on investment) produced. The consumer receives a content rich email with functionality not previously available within the body of an email.

Using the system it becomes possible to collect, process and insert dynamic data into an email body without launching additional windows or leaving the users mail reader application, the transaction is completed within the email body of a single email. Communications to back office systems allows for data processing to be sophisticated transactions or simpler data collection including sale or non-sale based transactions. Furthermore, as described in more detail further below, an alternative content mechanism is provided to facilitate users in environments that do not allow the rich content to be displayed.

It is also important to note that email has become a malevolent breeding ground for the distribution of viruses. Measures to curb the veracity of e-mail as medium for viruses have lead to client-side scripting languages such as JavaScript and VBScript being prohibited by default in all most all mail reading applications. Client-side scripting languages are commonly used within the art to provide a richer and more dynamic experience to the end-user, but because of the threat of infection from viruses these are generally not available to the email marketeer to use within the creative content of an email marketing campaign. Attempting to use client-side scripting languages in an email marketing campaign would, render the email useless as most of the intended recipients would not see the email.

Preferred embodiments of the present invention therefore use plugins (or virtual machines) such as Java and Flash. These plugins/virtual machines are sand-boxed (the term sand-boxed is well known in the art and refers to technologies that provide environments in which programs run, these programs are insulated from the host machine by the plugin or virtual machine i.e. they have no actual access to system resources). It is this architecture which provides insulation from attack by viruses. Such plugins and virtual machines also provide additional functionality above and beyond what is available using HTML alone.

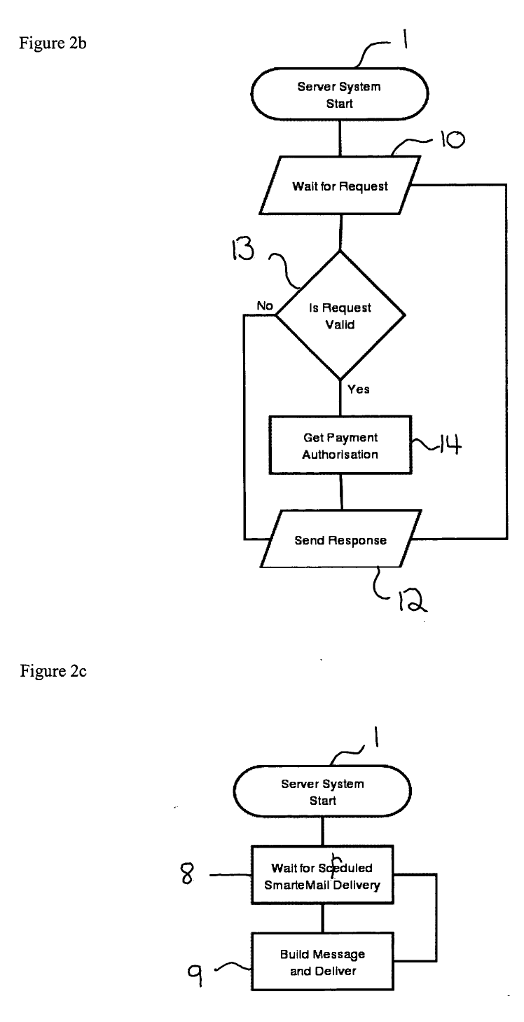

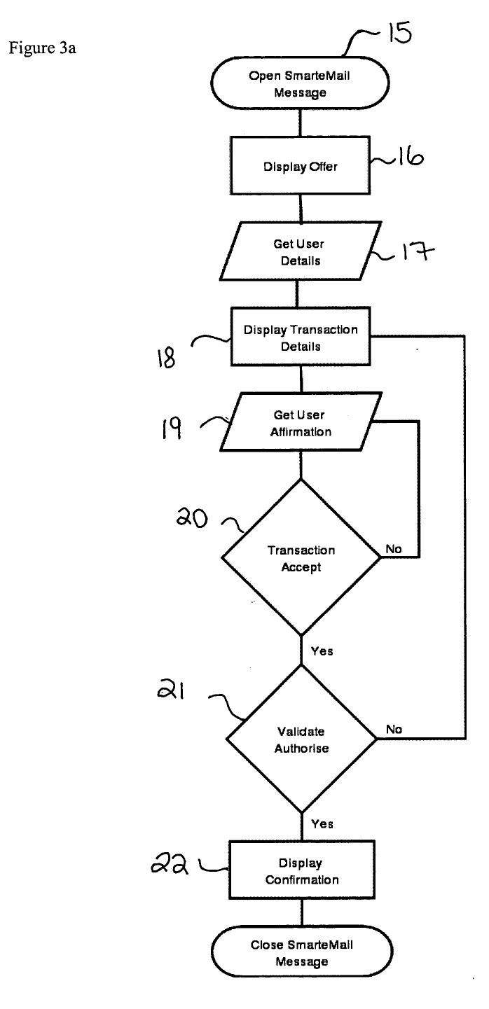

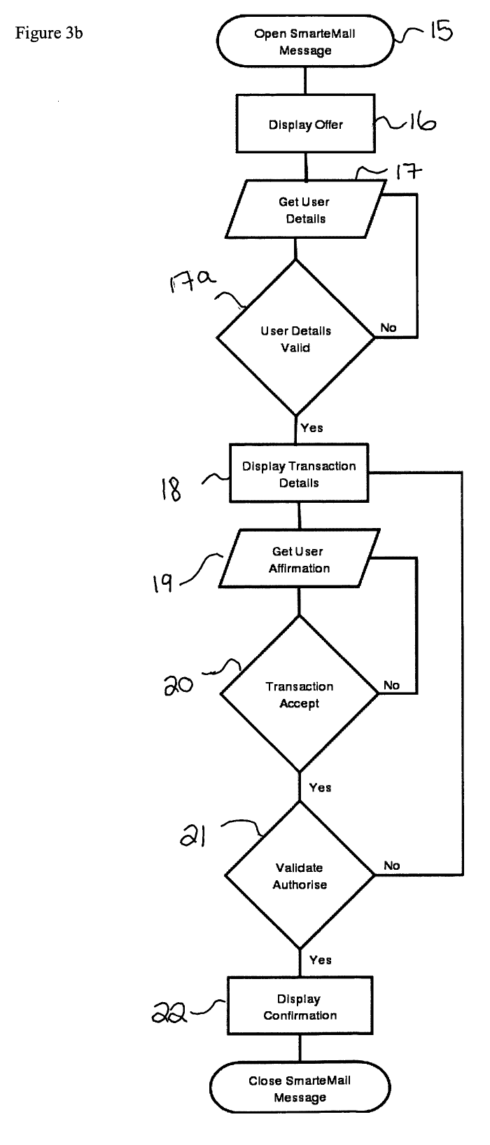

FIGS. 2 and 3 illustrate the process by which the system of FIG. 1 operates to effect a transaction.

It is necessary in the first instance to create the email content. This may be done at the server system 1 or, alternatively, the content may be created elsewhere and supplied to the server system 1 for delivery to recipients mail applications.

In this preferred embodiment, the initial email content is created using an HTML template which when rendered allows for an object to be embedded into the page, i.e. into the body of the email. The object is contained within a table cell and the table itself has a background image associated with it. The currently preffered form of object is a flash movie.

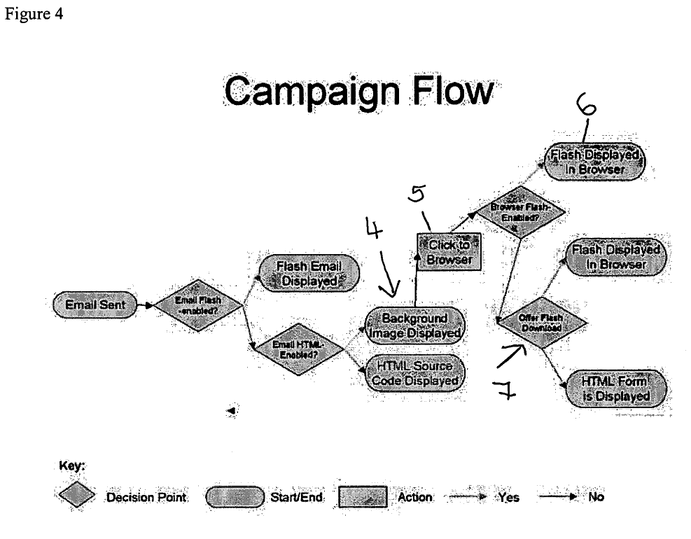

As illustrated in FIG. 4, if the object embed cannot function, perhaps because SMTP filtering software has commented it out or removed the EMBED and OBJECT HTML sections from the email on delivery (i.e. parts of the HTML code essential to embed the object), or because the requisite plugin or extension (e.g. a flash plugin where the object is a flash movie) has not been detected, then the background image is displayed (see 4), thus allowing alternative content to facilitate users not able to view the object.

The alternative content directs the user at 5 to click on an active link at the foot of the mail which if activated launches an external window 6 and allows a second chance to view the rich media content (i.e. the content associated with the object intended to be embedded in the email). If however the rich media content is still unable to run, perhaps because the requisite plugin is not available, the user is presented with an HTML equivalent (see 7) of the offer and/or directed to the appropriate site from which they may acquire the requisite plugin.

As demonstrated in FIG. 2c, the server system 1 can be configured to deliver the email messages (“SmarteMails”) to multiple recipients in accordance with a schedule. Once started, the server waits for the scheduled delivery time 8, builds the desired email message and dispatches it to the intended recipient or recipients 9. In this way a number of separate e.g. marketing campaigns may be scheduled and left to execute automatically.

Looking at the client side process in more detail, the email message content is initially loaded via a small HTML template page. This page enables alternative content to be selected without the use of client side scripting languages. This is particularly useful for delivery to some Webmail and other hostile environments where policy restricts full rich media operation of the system. Mail reader security settings can also affect operation where, for example, activeX controls are prohibited. In these situations the Object is not rendered and table background can be seen.

In this implementation the object (e.g. flash movie) if loaded succesfully, will cover the background so the user will not see the alternative content. The draw back of using table background as alternative content is that it is passive, that is to say, it is not possible to facilitate any interaction with this background image. In order that users may react to the alternative content a link is placed within the email message. This link may be displayed irrespective of which content is displayed and is positioned so as not to detract from the message when rich media content (e.g. a flash movie) is rendered, but is made obvious when alternative content is rendered.

The ‘call to action’ in the alternative content is to click the link.

Requests for the alternate content link (i.e. where the object cannot be loaded into the email), which is dynamically generated by the server system at message build and includes all merge information in a query string, are handled by a server side script. The server will dynamically generate a personalised page based on the contents of the query string passed into it for display. It responds with a page which includes browser detection code (well known in the art) to decide whether to issue the user with the email rich media content (in a browser window) or take some other action such as prompt the user to download an appropriate plugin or load an HTML version of the offer.

At the point that this link is clicked a browser window would be opened and it becomes permissible to attempt to use client side scripting languages.

The email messages can be personalised to suit each individual recipients profile, the information required by the email is inserted into the query string of the URL for the flash movie at message build time by the server system. When the flash movie is loaded the variables in its query string are made available internally to the movie so they can be displayed within the movie. It is also possible to retrieve information from the server system specific to the individual recipient (i.e. Info On Demand), but it must be kept in mind that any information required for early on in the movie should be made available as early as possible or else time constraints may cause problems. For example if the first frame of the movie requires the users sex to determine content and this were to be grabbed from the server at movie run-time, the first frame cannot be displayed until server interaction has completed. In this situation it would be prudent to include the value in the query string at build time.

The rich media content is currently handled using Macromedia Flash [http://www.macromedia.com]. This plugin is distributed as a core component of many commercial operating systems and is available at no cost for many others.

The first Object of the email message to be loaded is a stub movie, which detects the version of flash available on the recipients machine and initiates download of the most appropriate version of the real content.

The full benefits of Flash become available within the email, including server side communication and dynamic content.

Communication to the server system is performed using ActionScript LOADVARS calls to the server modules within the server system using HTTP or HTTPS. This is akin to using server side scripts and CGI (Common Gateway Interface), methods well known in the art.

The requested module then follows these steps (see FIG. 2a:
1. reads the query string passed with the request 10;
2. process the data 11;
3. execute commands and retrieve any required data;
4. respond to the email message 12.

As illustrated in FIG. 2b, this server process may, in some embodiments, check the validity of a request from the “SmarteMail” 13 and/or, in the case where the request includes a financial transaction, obtain payment authorisation 14.

The response to the Email message by the Server system is communicated using HTTP or HTTPS. It would typically contain a set of name/value pairs in plain text. For example a request to store a transaction might respond with ‘stat=AOK’ on successful completion. If however some error occurs, the response might be ‘stat=ERR&det=could not open file’. In this situation the “SmarteMail” message will report to the user that an error has occurred and ask them to email support or take other action which may be campaign specific, by displaying an appropriate message within the body of the email.

A second error condition may occur when the “SamrteMail” message receives no response from the Server system, perhaps because of a network fault. The Email message will time out after a number of seconds and again display a message to notify the fault to the user so he/she can take action.

The server system preferably provides a web analytics engine to measure campaign effectiveness. The system utilises a server system tracking functionality and information is sent to the server system from the “SmarteMail” every time the user accesses new content, e.g. a new frame of the flash movie. With flash, this can be achieved by making a request using LOADVARS to the Server systems tracking module over HTTP or HTTPS. The request contains a virtual path, the virtual path is populated with information about the campaign, distribution segment and user. It also contains a random number generated within Flash, which is used to prevent caching. The server system-tracking module records the request and responds with a very small packet.

The email messages can perform client side validation using ActionScript from within Flash, this allows for a much more interactive and responsive user experience. Data entered by the end-user is validated in the email message. If the data entered does not comply with the required format the end-user is notified and asked to correct the erroneous field (by displaying an appropriate message within the body of the email).

To enable the email messages to validate data that requires a third party data source the server system (or a third party server system or web service) can be contacted via an HTTP or HTTPS LOADVARS call to the appropriate program or module within the server or other system or service, including relevant data to be validated within the query string. The server or other system or service will perform the validation and supply the email message with an appropriate response. If the email message receives no response within a given time period validation is assumed to have failed.

FIGS. 3a and 3b show two exemplary processes by which the dynamic content of the “SmarteMail” (e.g. a Flash movie) can operate to complete a transaction. The process in 3b includes the additional step of validating the user's details 17a. These processes will be better understood by considering a specific example.

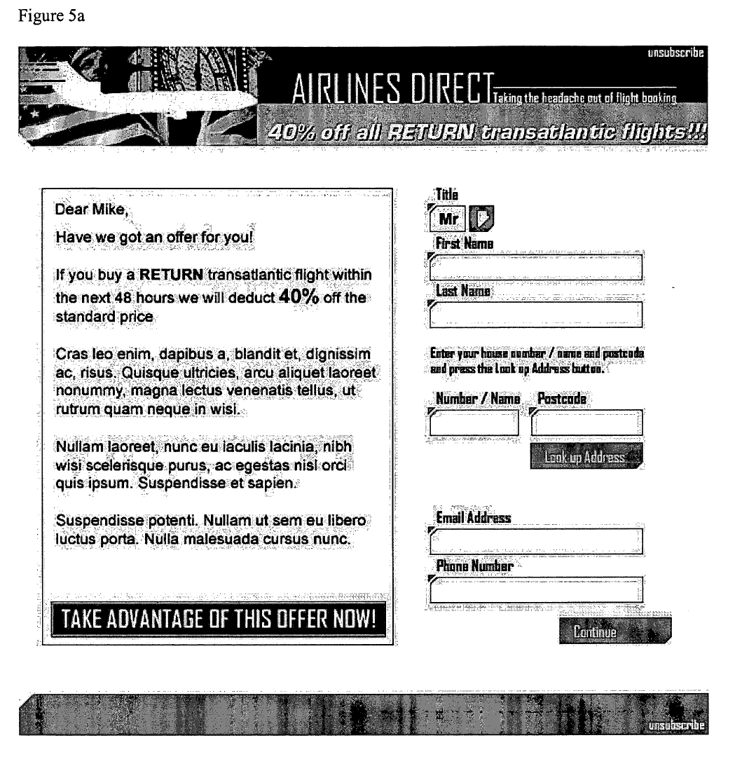

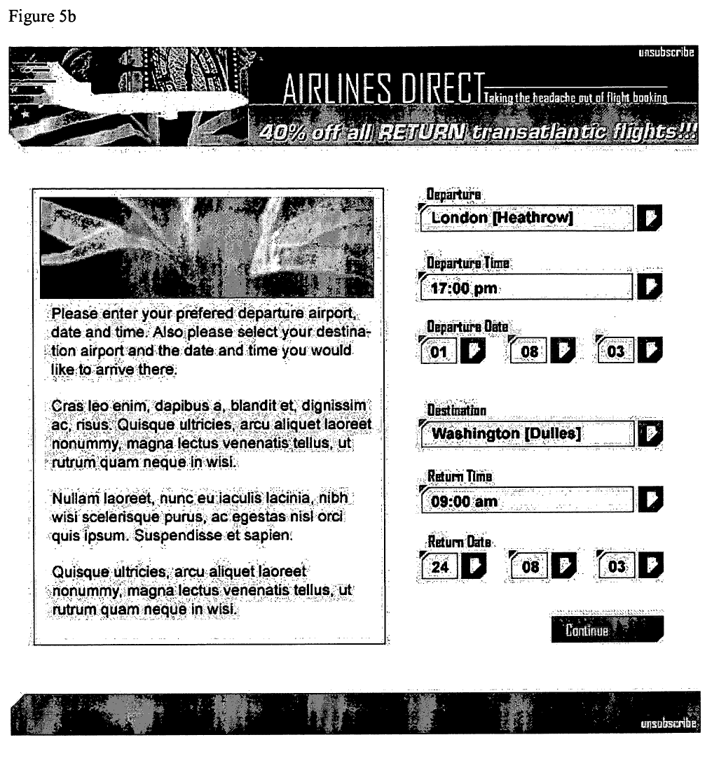

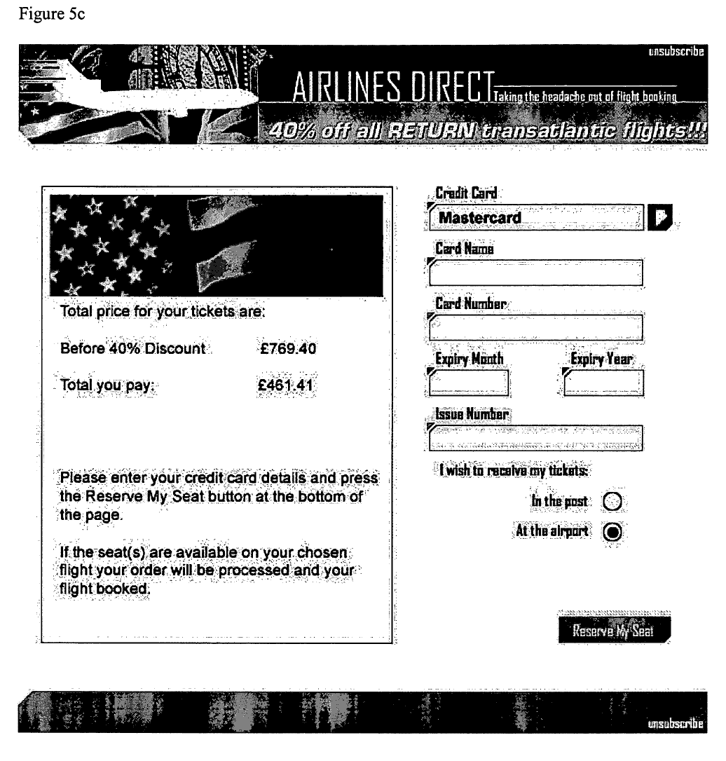

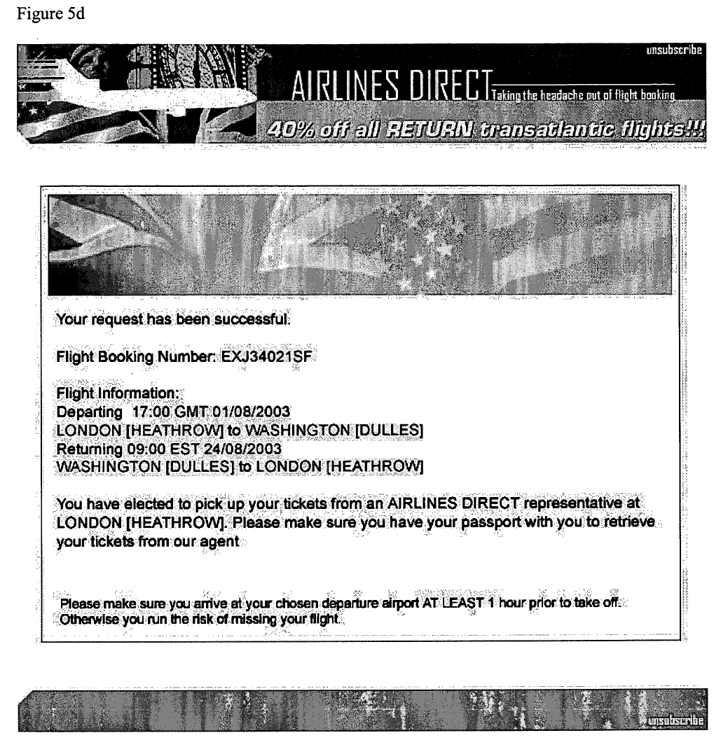

FIG. 5 illustrates one example of how a “SmarteMail” in accordance with an embodiment of the invention might be used. The specific example here is delivery of a sales campaign executed by a company willing to offer airline flight bookings.

A SmarteMail is delivered to an end-user (‘recipient’) in the manner discussed above. When the email is opened 15 by the user in their mail reader application, a Flash movie object is loaded and displayed within the body of the email.

As shown in FIG. 5a, the first frame of the movie presents the user with the offer 16, along with a first data entry panel for capturing the user's personal details 17. As can be seen in this figure, the message content has been personalised to salute the recipient by first name.

Additional personalisation is included in a non-displayed segment of the content (i.e. is not presented to the user) and is used for identification when communicating with the server system.

The end-user is able to view Flash content of the email and, in this example, is presented with a limited time offer for reduced price transatlantic flights.

The end user enters their personal details (name, address, email address and phone number) 17 and then ‘clicks’ the “Continue” button. In this example, the movie includes an address look-up function based on the user's postcode entry. When the user enters their postcode and clicks the “Look up Address” button, the flash movie communicates (in the manner discussed above) with the server system to dynamically validate the postcode and retrieve the associated address data from a third party database system. The address information is then automatically filled in within the body of the email.

When the user clicks “Continue” the flash movie may validate the data entered (e.g. to check that the necessary data fields have been completed and that the email address and phone number are in a valid format). If any errors are detected, an appropriate message is displayed within the movie (i.e. within the body of the email) to the user. Otherwise the flash movie proceeds to display the next data entry page illustrated in FIG. 5b. This simply involves display of another frame of the movie, still within the single email message.

The second data entry page, as seen in the figure, invites the user to select their preferred departure airport, date and time and destination information. The user selects their preferences from ‘drop down menus’, the content of which may be included in the original movie or some or all of the menus may be populated with data in real time through communication with the server or another system or service. For instance, the movie may communicate in real time with a third party flight schedule web service to populate the menu choices.

Having made their selection, the user clicks “Continue”, at which point there may be some validation of the data internally within the movie (e.g. is the departure date before the return date?) or via communication with an external system or service (e.g. are seats still available on the selected flight?). Assuming the validation is successful, the movie displays the next frame illustrated in FIG. 5c.

The user is presented with a message giving the price of the flight they have requested 18 and is prompted for their payment details (in this example credit card details, but other payment options may be offered, such as bank transfer, direct debit, invoice, etc) 19. The user also indicates, using the ‘radio buttons’ at the bottom of the data entry panel, whether they wish to receive their tickets in the post or pick them up at the airport.

As with the previous data entry screens, the payment information may be validated on entry. For instance, on entering his/her credit card number the validity of the number can be checked through communication with the server system. If it is invalid, an appropriate message can be displayed to the user straightaway in the movie before they proceed further.

To submit their order, the user then clicks the “Reserve My Seat” button 20. The order is transmitted to the server system and, in real time, the credit card transaction is executed 21. If at this point it is determined that the user has insufficient credit, an appropriate error message is sent back to the movie and a corresponding message is displayed to the user.

If the credit card transaction is settled satisfactorily a confirmation message is sent to the movie in the SmarteMail, which is then displays a confirmatory message to the user 22, as shown in FIG. 5d. As seen in this figure, the message displayed to the user includes an order reference number, in this example a booking reference number provided by the server system, along with confirmatory details of the flight that has been booked.

In this way, the complete transaction to purchase a flight has been completed from within a single email.

Various modifications to the specifically described examples above are possible within the scope of the present invention. For instance, email messages in accordance with embodiments of the inventions may also be composed of HTML containing a component such as a transaction component. In this guise the mail is composed in the standard way using HTML elements and has a Flash movie embedded into an area of the canvas. The detection method described above is used to fill the component area with an alternative image if the plugin is unable to operate. The component retains all the features of the exemplary message described above but is embedded into larger HTML page i.e. the amount of actual HTML is greater.

1. A system for conducting a transaction via an electronic mail message, the system comprising:
a first server component for sending an electronic mail message to a recipient;
a second server component for receiving data;
a third server component for effecting a transaction in response to data received by the second server component;
a client mail application for receiving the electronic mail message from the first server component, displaying the message to the recipient and enabling a recipient to interact with the message;
the electronic mail message comprising content that includes means for enabling communication with the second server component whilst the message is displayed to the recipient for sending data to the second server component in response to the recipient's interaction with the message.

2. A system according to claim 1, comprising one or more server components for sending data to the mail message to enable two-way communication between an electronic mail message displayed to the recipient and one or more server components.

3. A system according to claim 1 wherein the content of the electronic mail message for enabling communication with the second server component comprises an object or component embedded in the message.

4. A system according to any one of claims 1, wherein the content of the electronic mail message for enabling communication with the second server component comprises means for loading on or after opening of the message an object or component to be displayed within the mail message to the recipient.

5. A system according to claim 4 wherein the object or component comprises a mail reader application component or enhancement that provides a dynamic environment with which a recipient of the message can interact.

6. A system according to claim 5 wherein the object or component comprises a plug-in component or virtual machine.

7. A system according to claim 6 wherein the object or component comprises a flash movie.

8. A system according to claim 6 wherein the object or component comprises a Java applet.

9. A system according to claim 4 wherein the object or component comprises means to validate data entered by a recipient of the message.

10. A system according to claim 9 wherein the means to validate data operates to validate the data with reference to rules or data held locally by the object or component.

11. A system according to claim 9 wherein the means to validate data comprises means for communicating with a server component to validate data with reference to external rules or data sources.

12. A system according to claim 4 wherein the object or component is sand-boxed.

13. A system according to claim 1 wherein the electronic mail message includes alternative content that is visible to the recipient in the event that the means for communicating with the second server component is inoperable.

14. A system according to claim 1 comprising a server component for generating the electronic mail message to be sent.

15. A system according to claim 14, comprising a store of one or more mail message templates accessible by the server component for generating the electronic mail message.

16. A system according to claim 1 wherein the electronic mail message is personalised for a particular recipient or group of recipients.

17. A system according to claim 1, wherein the third server component comprises means for storing the received data in a data store.

18. A system according to claim 1, wherein the third server component comprises means for forwarding the data to another address, application, service or system.

19. A system according to claim 1, wherein the third server component comprises means for interacting with one or more payment gateways and/or other applications, services or systems responsible for fulfilment of an order.

20. A server system for conducting a transaction via an electronic mail message, the server system comprising:
a first server component for sending an electronic mail message to a recipient;
a second server component for receiving data; and
a third server component for effecting a transaction in response to data received by the second server component;
the electronic mail message comprising content that includes means for enabling communication with the second server component whilst the message is displayed to the recipient for sending data to the second server component in response to a recipient's interaction with the message.

21. An electronic mail message comprising content that includes means for enabling communication with a server component whilst the message is displayed to a recipient for sending data to the server component in response to interaction of the recipient with the displayed message.

22. An electronic mail message according to claim 21, comprising means for receiving data from one or more server components to enable two-way communication between the electronic mail message when displayed to a recipient and the one or more server components.

23. An electronic mail message according to claim 21 wherein the content of the electronic mail message for enabling communication with the server component comprises an object or component embedded in the message.

24. An electronic mail message according to claim 21 wherein the content of the electronic mail message for enabling communication with the server component comprises means for loading on or after opening of the message an object or component to be displayed within the mail message to the recipient.

25. An electronic mail message according to claim 24 wherein the object or component comprises a mail reader application component or enhancement that provides a dynamic environment with which a recipient of the message can interact.

26. An electronic mail message according to claim 25 wherein the object or component comprises a plug-in component or virtual machine.

27. An electronic mail message according to claim 26 wherein the object or component comprises a flash movie.

28. An electronic mail message according to claim 26 wherein the object or component comprises a Java applet.

29. An electronic mail message according to claim 24 wherein the object or component comprises means to validate data entered by a recipient of the message.

30. An electronic mail message according to claim 29 wherein the means to validate data operates to validate the data with reference to rules or data held locally by the object or component.

31. An electronic mail message according to claim 29 wherein the means to validate data comprises means for communicating with a server component to validate data with reference to external rules or data sources.

32. An electronic mail message according to claim 24 wherein the object or component is sand-boxed.

33. An electronic mail message according to claim 21 comprising alternative content that is visible to the recipient in the event that communication with the a server component is inoperable.

34. An electronic mail message according to claim 21 wherein the message is personalised for a particular recipient or group of recipients.

35. A method for conducting a transaction via an electronic mail message, the method comprising:
sending an electronic mail message from a first server component to a recipient;
receiving the electronic mail message at a client mail application, the mail application displaying the message to the recipient and enabling the recipient to interact with the message;
in response to interaction of the recipient with the electronic mail message, the message content operating to communicate with a second server component whilst the message is displayed to the recipient to send data to the second server component;
the second server component receiving the sent data; and
effecting a transaction in response to the data received by the second server component.

36. A method according to claim 35, comprising sending data from one or more server components to the mail message to enable two-way communication between an electronic mail message displayed to a recipient and one or more server components.

37. A method according to claim 35 comprising validating data entered by a recipient of the message.

38. A method according to claim 37 wherein the data is validated with reference to rules or data held locally at the client mail application.

39. A method according to claim 37 wherein the data comprises is validated with reference to external rules or data sources.

40. A method according to claim 35 where in the event that the means for communicating with the second server component is inoperable alternative content is displayed to the recipient within the electronic mail message.

41. A method according to claim 35 comprising generating the electronic mail message to be sent.

42. A method according to claim 41, wherein a mail message template is used for generating the electronic mail message.

43. A method according to claim 35 comprising personalising the electronic mail message for a particular recipient or group of recipients.

44. A method according to claim 35 comprising storing the received data in a data store.

45. A method according to claim 35 comprising forwarding the received data to another address, application, service or system.

46. A method according to claim 35 comprising interacting with one or more payment gateways and/or other applications, services or systems responsible for fulfilment of an order.

47. A method for conducting a transaction via an electronic mail message, the method comprising:
sending an electronic mail message from a first server component to a recipient, the electronic mail message comprising content that includes means for enabling communication with a second server component whilst the message is displayed to the recipient for sending data to the second server component in response to the recipient's interaction with the message;
receiving at the second server component data sent in response to interaction of the recipient with the electronic mail message; and
effecting a transaction in response to the data received by the second server component.

48. A method for conducting a transaction via an electronic mail message, the method comprising:
receiving an electronic mail message at a client mail application, the mail application displaying the message to a recipient and enabling the recipient to interact with the message;
in response to interaction of the recipient with the electronic mail message, the message content operating to communicate with a second server component whilst the message is displayed to the recipient to send data to the second server component in order to effect the transaction.

49. A system according to claim 48 comprising the electronic mail message receiving data from a server component whilst it is displayed to the recipient to enable two-way communication between the electronic mail message displayed to the recipient and one or more server components.

50. A method according to claim 48 comprising on or after opening of the message communicating with a server component and loading an object or component to be displayed within the mail message to the recipient.

51. A method according to claim 48 comprising validating data entered by a recipient of the message.

52. A method according to claim 51 wherein the data is validated with reference to rules or data held locally at the client mail application.

53. A method according to claim 51 wherein the data comprises is validated with reference to external rules or data sources.

54. A method according to claim 48 where in the event that the means for communicating with the second server component is inoperable alternative content is displayed to the recipient within the electronic mail message.
